(19) United States
(12) Patent Application Publication
(10) Pub. No.: US 2018/0333843 A1
(43) Pub. Date: Nov. 22, 2018

(54) REMOTE CONTROL SYSTEM, A METHOD FOR CONTROLLING A PLURALITY OF CONTROLLED DEVICES, AND A REMOTE CONTROL MECHANICAL DEVICE ASSEMBLY COMMUNICABLE WITH A SERVER UNIT

(71) Applicant: National Taiwan Normal University, Taipei City (TW)

(72) Inventors: Jon-Chao HONG, Taipei City (TW); Yi-Hsuan HUNG, Taipei City (TW); Chi-Ruei TSAI, Taipei City (TW); Kai-Wen TAI, Taipei City (TW); Kai-Hsin TAI, Taipei City (TW)

(73) Assignee: National Taiwan Normal University, Taipei City (TW)

(21) Appl. No.: 15/599,042

(22) Filed: May 18, 2017

(51) Int. Cl. B25J 9/00; H04L 29/08; B25J 9/16

(52) U.S. Cl. CPC B25J 9/0084; B25J 9/161; H04L 67/125

(57) ABSTRACT

The remote control system includes a server unit and a remote controlling device receiving input of a first action command. The remote controlling device transmits the first action command to a first controlled device so as to enable the first controlled device to perform a first action and to transmit a relevant notice to the server unit. The server unit transmits, when receiving the notice, to each of second controlled devices, a respective one of second action commands that is included in a second action command set corresponding to the first action command, and that enables the second controlled device to perform a second action corresponding to the respective one of the second action commands.

### FIELD

The disclosure relates to a remote control system, and more particularly to a remote control system for controlling a plurality of controlled devices.

### BACKGROUND

Mechanical devices, such as robots, have been used widely in various fields, e.g., manufacturing, customer service, medical service, household management, educational assistance, and so forth. Some tasks require participation of a plurality of robots, and approaches to simultaneously control the plurality of robots are demanded.

### SUMMARY

Therefore, an object of the disclosure is to provide a remote control system that can simultaneously control a plurality of controlled devices.

According to one aspect of the disclosure, the remote control system is utilized for remotely controlling a first controlled device and a plurality of second controlled devices. The remote control system includes a remote controlling device and a server unit. The remote controlling device is configured to be operated for input of one of a plurality of first action commands, and is communicable with the first controlled device. The server unit is communicable with the first controlled device and the plurality of second controlled devices. The server unit stores a plurality of second action command sets which correspond respectively to the plurality of first action commands. Each of the plurality of second action command sets includes a plurality of second action commands which correspond respectively to the plurality of second controlled devices. The remote controlling device is configured to transmit the first action command thus inputted thereto to the first controlled device. The first action command thus inputted enables the first controlled device to, when the first controlled device receives the first action command thus inputted, perform a first action corresponding to the first action command thus inputted based thereon, and transmit, to the server unit, a notice related to the first action command thus inputted. The server unit is configured to, when receiving the notice, transmit, to each of the plurality of second controlled devices, a respective one of the second action commands that is included in one of the second action command sets corresponding to the first action command thus inputted, and that enables the second controlled device to, when the second controlled device receives the respective one of the second action commands, perform a second action corresponding to the respective one of the second action commands thus received based thereon.

According to another aspect of the disclosure, a method is used for remotely controlling a first controlled device and a plurality of second controlled device. The method is to be implemented by a remote control system which includes a remote controlling device and a server unit. The remote controlling device is configured to be operated for input of one of a plurality of first action commands. The server unit stores a plurality of second action command sets which correspond respectively to the plurality of first action commands. Each of the plurality of second action command sets includes a plurality of second action commands which correspond respectively to the plurality of second controlled devices. The method includes the steps of:

a) transmitting, by the remote controlling device, the first action command thus inputted thereto to the first controlled device, the first action command thus inputted enabling the first controlled device to perform, when the first controlled device receives the first action command thus inputted, a first action corresponding to the first action command thus inputted based thereon, and to transmit, to the server unit, a notice related to the first action command thus inputted; and

b) transmitting, by the server unit when receiving the notice, to each of the plurality of second controlled devices, a respective one of the second action commands that is included in one of the second action command sets corresponding to the first action command thus inputted, and that enables the second controlled device to perform, when the second controlled device receives the respective one of the second action commands, a second action corresponding to the respective one of the second action commands thus received based thereon.

According to still another aspect of the disclosure, a remote control mechanical device assembly is communicable with a server unit. The server unit stores a plurality of first action commands and a plurality of second action command sets which correspond respectively to the plurality of first action commands. Each of the plurality of second action command sets includes a plurality of second action commands. The remote control mechanical device assembly includes a remote controlling device, a first controlled device and a plurality of second controlled devices. The remote controlling device is configured to be operated for input of one of the plurality of first action commands. The first controlled device is communicable with the remote controlling device and the server unit. The second controlled devices are communicable with the server unit. The plurality of second action commands that are included in each of the plurality of second action command sets correspond respectively to the plurality of second controlled devices. The remote controlling device is configured to transmit, to the first controlled device, the first action command thus inputted to the remote controlling device. The first controlled device is configured to, when the first controlled device receives the first action command thus inputted, perform a first action corresponding to the first action command thus inputted based thereon, and transmit, to the server unit, a notice related to the first action command thus inputted, such that the notice enables the server unit to, when receiving the notice, transmit to each of the plurality of second controlled devices, a respective one of the second action commands that is included in one of the second action command sets corresponding to the first action command thus inputted. The second controlled device is configured to, when the second controlled device receives the respective one of the second action commands, perform a second action corresponding to the respective one of the second action commands thus received based thereon.

### BRIEF DESCRIPTION OF THE DRAWINGS

Other features and advantages of the disclosure will become apparent in the following detailed description of the embodiment with reference to the accompanying drawings, of which:

FIG. 1 is a schematic diagram illustrating an embodiment of a remote control system according to the disclosure; and

FIG. 2 is a flow chart illustrating an operation flow of the remote control system and first and second controlled devices during implementation of a method for remotely controlling the first and second controlled devices according to the disclosure.

### DETAILED DESCRIPTION

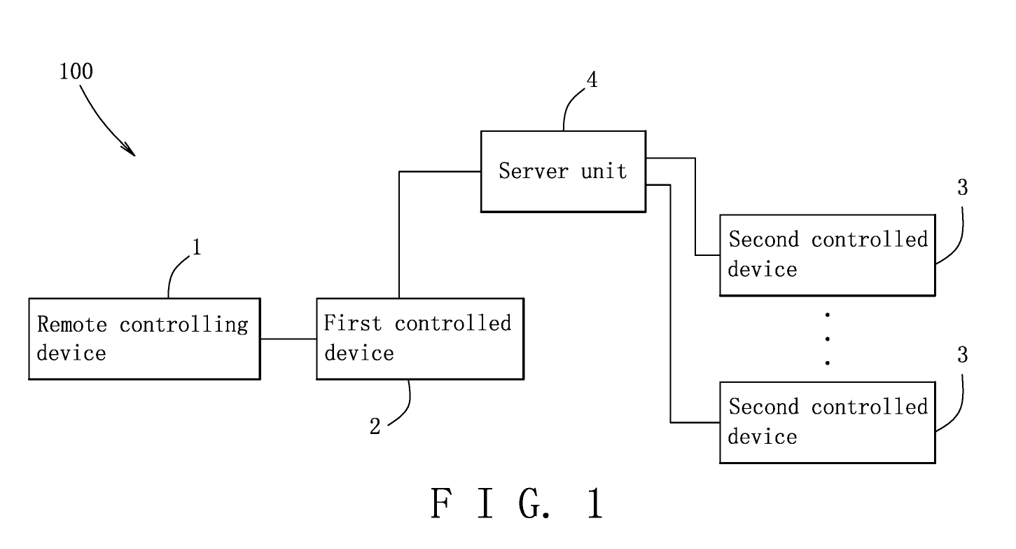

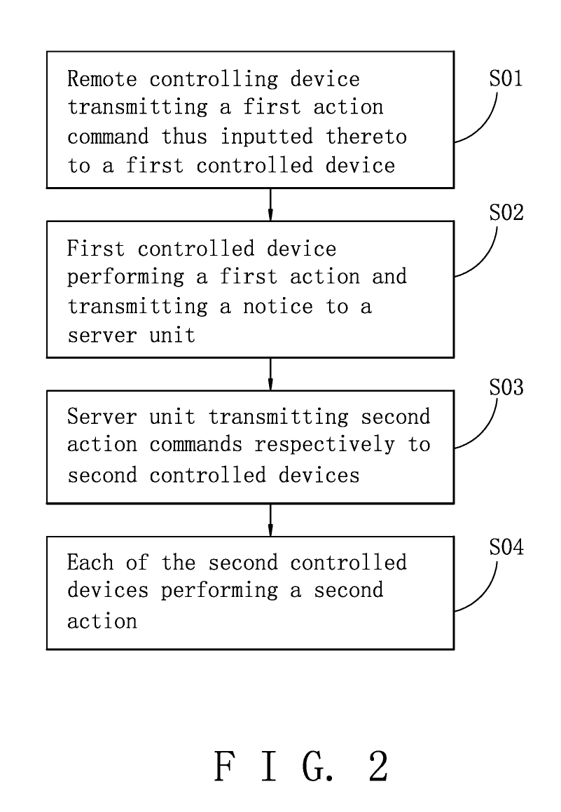

Referring to FIGS. 1 and 2, an embodiment of a remote control system 100 for remotely controlling a first controlled device 2 and a plurality of second controlled devices 3 is illustrated. The remote control system 100 includes a remote controlling device 1 and a server unit 4. In this embodiment, the first controlled device 2 and the plurality of second controlled devices 3 are implemented by robots, but implementations of the first controlled device 2 and the plurality of second controlled devices 3 may vary in other embodiments. For example, the first controlled device 2 and the plurality of second controlled devices 3 may be implemented by radio-controlled aircrafts or unmanned aerial vehicles.

The remote controlling device 1 is configured to be operated by a user for input of one of a plurality of first action commands, and is communicable with the first controlled device 2. For example, the remote controlling device 1 may be provided with an interface such as one or more buttons or a graphical user interface for the user to input the desired first action command, and may be wirelessly communicable with the first controlled device 2 by means of, e.g., a short-range communication technology. The remote controlling device 1 may be implemented by, for instance, a remote controller, a smartphone, a notebook or any electronic device provided with applicable communication protocols for implementing remote control functionality.

The server unit 4 is communicable with the first controlled device 2 and the plurality of second controlled devices 3. For example, the server unit 4 is wirelessly communicable with the first controlled device 2 and the plurality of second controlled devices 3 by means of, e.g., a mobile communication technology. The server unit 4 stores the plurality of first action commands, and a plurality of second action command sets which correspond respectively to the plurality of first action commands. Each of the plurality of second action command sets includes a plurality of second action commands which correspond respectively to the plurality of second controlled devices 3. In this embodiment, the second action commands included in each of the second action command sets are different from each other. However, in other embodiments, some of the second action commands included in one of the second action command sets may be identical. The server unit 4 may be exemplified as a server computer, a database server, a computing server or any server capable of processing data, performing computation and sharing data with multiple clients so as to facilitate remote control.

The remote controlling device 1 is configured to transmit, when receiving an input of one of the first action commands (hereinafter referred to as the “first action command thus inputted”), the first action command thus inputted to the first controlled device 2. The first action command thus inputted enables the first controlled device 2 to, when the first controlled device 2 receives the first action command thus inputted, perform a first action corresponding to the first action command thus inputted based thereon, and transmit to the server unit 4 a notice related to the first action command thus inputted. For example, the notice may be generated by the first controlled device 2 and may indicate which one of the first action commands is the first action command received by the first controlled device 2.

The server unit 4 is configured to, when receiving the notice, locate one of the second action command sets that corresponds to the first action command thus inputted based on the notice, and transmit to each of the plurality of second controlled devices 3 a respective one of the second action commands that is included in the located one of the second action command sets, and that enables the second controlled device 3 to, when the second controlled device 3 receives the respective one of the second action commands, perform a second action corresponding to the respective one of the second action commands thus received.

In the following description, a method for remotely controlling the first controlled device 2 and the plurality of second controlled device 3 to be implemented by the remote control system 100 which is previously mentioned will be explained. FIG. 2 depicts an operation flow of the remote control system 100 and the first and second controlled devices 2, 3 during implementation of the method.

In step S01, the remote controlling device 1 of the remote control system 100 transmits one of the first action commands thus inputted to the first controlled device 2.

The first action command thus inputted enables the first controlled device 2 to perform, when the first controlled device 2 receives the first action command thus inputted, a first action corresponding to the first action command thus inputted based thereon, and to transmit to the server unit 4 the notice related to the first action command thus inputted. Therefore, in step S02, the first controlled device 2, upon receipt of the first action command thus inputted, performs the first action corresponding to the received first action command, and transmits the notice to the server unit 4.

In step S03, the server unit 4, when receiving the notice, locates one of the second action command sets that corresponds to the first action command thus inputted based on the notice, and transmits to each of the plurality of second controlled devices 3 a respective one of the second action commands that is included in the one of the second action command sets thus located.

For each of the plurality of second controlled devices 3, the respective one of the second action commands enables the second controlled device 3 to perform, when the second controlled device 3 receives the respective one of the second action commands, a second action corresponding to the respective one of the second action commands thus received based thereon. Therefore, in step S04, upon receipt of the respective one of the second action commands, each second controlled device 3 performs the second action corresponding to the received respective second action command.

It should be noted that the first controlled device 2 and the plurality of second controlled devices 3 are each configured in advance to perform corresponding actions in response to receipt of the various first action commands or the second action commands. Moreover, the first controlled device 2 is further configured in advance to generate the notice in response to receipt of the first action command thus inputted based on the same, and to transmit the notice to the server unit 4.

Taking an example for explanation, the first controlled device 2 is implemented by a walking robot, and each of the plurality of second controlled devices 3 is implemented by a walking robot as well. The second controlled devices 3 are arranged to line up in a row, and the first controlled device 2 is placed in front of the row, such that it appears as if the first controlled device 2 is leading the plurality of second controlled devices 3. In step S01, the remote controlling device 1 of the remote control system 100 transmits one of the first action commands thus inputted by the user to the first controlled device 2 in an attempt to enable the first controlled device 2 to advance and turn left around a corner in a manner such as moving around a curve in a track, which is the first action corresponding to said one of the first action commands previously mentioned, and to generate and transmit a corresponding notice to the server unit 4. In step S02, the first controlled device 2, being enabled by the first action command received thereby, performs the first action and transmits the notice to the server unit 4. In step S03, when receiving the notice, the server unit 4 first finds out which one of the second command sets corresponds to the first action command according to the notice received thereby, and then transmits to each of the plurality of second controlled devices 3, a respective one of the second action commands of that second command set in an attempt to enable the plurality of second controlled devices 3 to advance and turn left around the corner (e.g., moving around the curve in the track) while keeping a fixed formation. It is worth to note that, in order to keep the fixed formation while turning around the corner, one of the second controlled devices 3 positioned nearer the corner should move at a relatively slower velocity, and another one of the second controlled devices 3 positioned farther from the corner should move at a relatively faster velocity, and the second action commands should appropriately reflect such difference so as to instruct the respective second controlled devices 3 to move at different velocities accordingly. In step S04, each of the second controlled devices 3, being enabled by a respective one of the second action commands, performs the corresponding second action, i.e., to advance and turn left around the corner, and to move at an appropriate velocity, such that the formation of the second controlled devices 3 is kept fixed while moving. As a result, an appearance that the first controlled device 2 leads a row of the plurality of second controlled devices 3 to march can be realized.

In summary, the remote control system 100 of this disclosure is configured in such a way that the remote controlling device 1 transmits the first action command to the first controlled device 2 so as to enable the first controlled device 2 to perform the first action and to transmit to the server unit 4 the notice related to the first action command, and in such a way that the server unit 4 transmits, when receiving the notice, to each of second controlled devices 3 a respective one of second action commands that is included in one of the second action command sets corresponding to the first action command thus inputted, and that enables the second controlled device 2 to perform the second action corresponding to the respective one of the second action commands. By appropriate arrangements, an appearance that the first controlled device 2 leads the second controlled devices 3 to take actions may be realized.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A remote control system for remotely controlling a first controlled device and a plurality of second controlled devices, said remote control system comprising:
a remote controlling device configured to be operated for input of one of a plurality of first action commands, and communicable with the first controlled device; and
a server unit communicable with the first controlled device and the plurality of second controlled devices, and storing a plurality of second action command sets which correspond respectively to the plurality of first action commands, each of the plurality of second action command sets including a plurality of second action commands which correspond respectively to the plurality of second controlled devices;
wherein said remote controlling device is configured to transmit, to the first controlled device, the first action command thus inputted to said remote controlling device, the first action command thus inputted enabling the first controlled device to, when the first controlled device receives the first action command thus inputted, perform a first action corresponding to the first action command thus inputted based thereon, and transmit, to said server unit, a notice related to the first action command thus inputted;
wherein said server unit is configured to, when receiving the notice, transmit to each of the plurality of second controlled devices, a respective one of the second action commands that is included in one of the second action command sets corresponding to the first action command thus inputted, and that enables the second controlled device to, when the second controlled device receives the respective one of the second action commands, perform a second action corresponding to the respective one of the second action commands thus received based thereon.

2. The remote control system as claimed in claim 1, wherein the second action commands included in each of the second action command sets are different from each other.

3. A method for remotely controlling a first controlled device and a plurality of second controlled device, the method to be implemented by a remote control system which includes a remote controlling device and a server unit, the remote controlling device being configured to be operated for input of one of a plurality of first action commands, the server unit storing a plurality of second action command sets which correspond respectively to the plurality of first action commands, each of the plurality of second action command sets including a plurality of second action commands which correspond respectively to the plurality of second controlled devices, the method comprising the steps of:
a) transmitting, by the remote controlling device, to the first controlled device, the first action command thus inputted to the remote controlling device, the first action command thus inputted enabling the first controlled device to perform, when the first controlled device receives the first action command thus inputted, a first action corresponding to the first action command thus inputted based thereon, and to transmit, to the server unit, a notice related to the first action command thus inputted; and
b) transmitting, by the server unit when receiving the notice, to each of the plurality of second controlled devices, a respective one of the second action commands that is included in one of the second action command sets corresponding to the first action command thus inputted, and that enables the second controlled device to perform, when the second controlled device receives the respective one of the second action commands, a second action corresponding to the respective one of the second action commands thus received based thereon.

4. The method as claimed in claim 3, wherein the second action commands included in each of the second action command sets are different from each other.

5. A remote control mechanical device assembly communicable with a server unit, the server unit storing a plurality of first action commands and a plurality of second action command sets which correspond respectively to the plurality of first action commands, each of the plurality of second action command sets including a plurality of second action commands, said remote control mechanical device assembly comprising:
a remote controlling device configured to be operated for input of one of the plurality of first action commands;
a first controlled device communicable with said remote controlling device and the server unit; and
a plurality of second controlled devices communicable with the server unit, the plurality of second action commands that are included in each of the plurality of second action command sets corresponding respectively to said plurality of second controlled devices;
wherein said remote controlling device is configured to transmit, to said first controlled device, the first action command thus inputted to said remote controlling device;
wherein said first controlled device is configured to, when said first controlled device receives the first action command thus inputted, perform a first action corresponding to the first action command thus inputted based thereon, and transmit, to the server unit, a notice related to the first action command thus inputted, such that the notice enables the server unit to, when receiving the notice, transmit to each of said plurality of second controlled devices, a respective one of the second action commands that is included in one of the second action command sets corresponding to the first action command thus inputted;
wherein said second controlled device is configured to, when said second controlled device receives the respective one of the second action commands, perform a second action corresponding to the respective one of the second action commands thus received based thereon.

6. The method as claimed in claim 5, wherein the second action commands included in each of the second action command sets are different from each other.
